(19) United States
(12) Patent Application Publication
(10) Pub. No.: US 2011/0292656 A1
(43) Pub. Date: Dec. 1, 2011

(54) LUMINAIRE COOLING APPARATUS

(75) Inventor: Sandeep Saxena, Novi, MI (US)

(73) Assignee: HELLA KG HUECK AND CO., Lippstadt (DE)

(21) Appl. No.: 13/115,668

(22) Filed: May 25, 2011

Related U.S. Application Data
(60) Provisional application No. 61/348,555, filed on May 26, 2010.

(51) Int. Cl. F21S 4/00; F21V 29/00

(52) U.S. Cl. 362/249.02

(57) ABSTRACT

An outdoor area light has a housing, a light source comprised of a printed circuit board, a plurality of LEDs, and a heat sink. The heat sink is disposed in thermally conductive proximity to said light source to conduct heat away from it for temperature control. The light source and heat sink are mounted in the housing. A passive impeller is mounted on the housing. A separate active impeller is also mounted on the housing. A conduit for air is in fluid communication with the active impeller and disposed to direct cooling air over the light source and/or the heat sink. The printed circuit board and/or the heat sink and/or their mounts have holes through them. The holes define fluid throughways disposed to convect heat away from the light source via air moving through the throughways. The fluid throughways may be sufficiently aligned to establish laminar flow through them. In high heat, the active impeller is engaged to cool the light; otherwise the passive impeller keeps the light cool.

### CROSS-REFERENCE

This application claims priority to U.S. Provisional Patent application No. 61/348,555 filed May 26, 2010.

### BACKGROUND OF THE INVENTION

1. Field of the Invention

The invention is in the field of exterior area lighting, particularly streetlights.

2. Related Art

Traditional cooling for outdoor area lighting such as street lights has failed to provide either adequate cooling or adequate control of energy costs. With newer technologies such as light emitting diodes (“LEDs”) providing greater energy efficiencies for a given quantity of light output, achieving corresponding cooling efficiencies would be advantageous.

### SUMMARY OF THE INVENTION

An outdoor area light has housing, a light source comprised of a printed circuit board, a plurality of LEDs, and a heat sink. The heat sink is disposed in thermally conductive proximity to said light source to conduct heat away from it for temperature control. The light source and heat sink are mounted in the housing. A passive impeller is mounted on the housing. A separate active impeller is also mounted on the housing. A conduit for air is in fluid communication with the active impeller and disposed to direct cooling air over the light source and/or the heat sink. The printed circuit board and/or the heat sink and/or their mounts have holes through them. The holes define fluid throughways disposed to convect heat away from the light source via air moving through the throughways. The fluid throughways may be sufficiently aligned to maintain minimally turbulent air flow there through and across the light source and may be sufficiently aligned to establish laminar flow through them. In high heat, the active impeller is engaged to cool the light; otherwise the passive impeller keeps the light cool.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a schematic side view of the Luminaire cooling system.

FIG. 2 is a schematic top view of the Luminaire cooling system.

FIG. 3 is a detail of the air conduit.

### DETAILED DESCRIPTION

Referring now to the drawings in which like reference numbers indicate like elements, the Luminaire 10, for example, a street light, of the present invention is comprised of a housing 12 and within it a light source 14. The light source 14 is an assembly comprised of at least a plurality of LEDs 16 mounted to, powered through and/or controlled by a printed circuit board 18. A heat sink 20 is mounted with, on or near the light source 14 in sufficient proximity to thermally conduct heat from said light source 14.

Each of said printed circuit board 18 and heat sink 20 are mounted with a mounting element 22, 24, which may be individual for each of the PCB 18 and heat sink 20, or which may be integral. For example, the PCB 18 may be mounted with and substantially surrounded by copper cladding 22.

Within PCB 18 are a plurality of throughholes 30. Within the mounting/cladding 22 of the PCB there are also a plurality of holes 32 beneath the PCB 18. Within the heat sink mount 24 there are also a plurality of throughholes 34 above the heat sink. There are also a plurality of throughholes 33 in any housing or cladding structure is between the PCB 18 and heat sink 20.

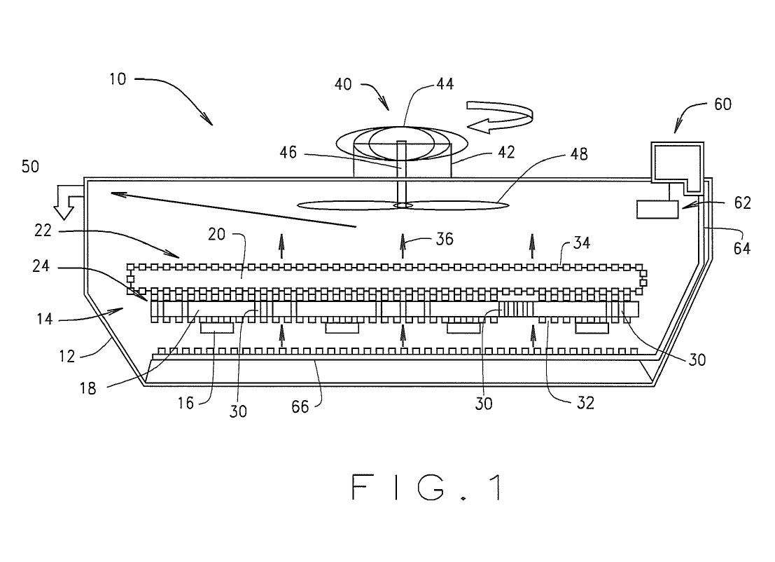

Holes 30, 32, 33 and 34 are disposed relative to one another in order to create, define and maintain throughways 36 through which a fluid such as air, may pass from one side of the assembly, i.e., below the light source 14 and through the assembly, with minimal turbulence. In the preferred embodiment, laminar flow would be achieved across the light source/heat sink assembly and/or within the throughways 36. The throughholes 32 and 33 may correspond to one PCB throughhole 30 as depicted on the left of FIG. 1, or may correspond to more than one PCB throughhole 30 as depicted on the right in FIG. 1.

The housing 12 supports a passive impeller assembly 40. The passive impeller assembly draws air across the light source/heat sink assembly and through the fluid throughways 36 in order to cool the assembly. The passive impeller 40 is not powered and, accordingly, uses no energy in the form of electricity to maintain cooling air flow in the majority of environmental circumstances. In the depicted embodiment the passive impeller 40 is comprised of a mount 42 that holds a wind driven fan 44 exposed to free air moving over the top of the housing 12. The wind driven fan is attached to an axle 46 that extends through the housing 12 and into the internal space within the housing 12. Inside the housing 12 the axle 46 is attached to and drives a passive cooling fan 48. Cooling fan 48 is oriented and disposed to draw air through the fluid throughways 36 and across the light source/heat sink assembly, thereby cooling it. A vent 50 is provided to allow an exit for the moving air.

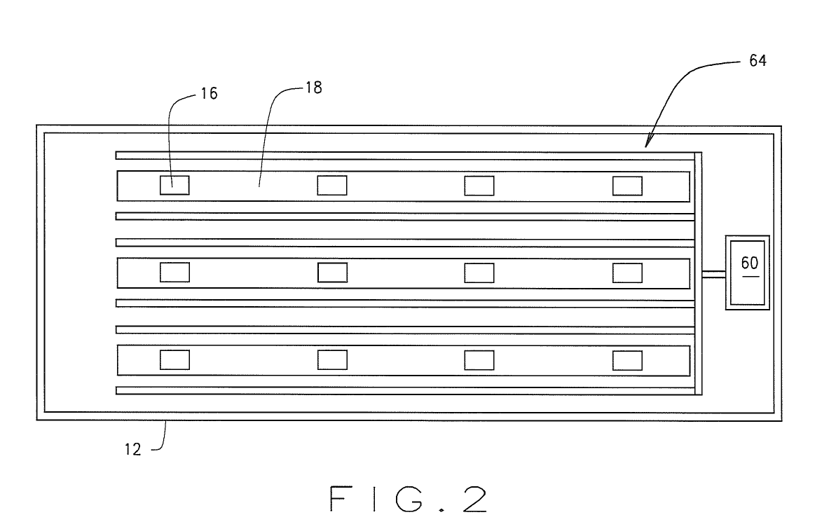

While advantageous for its power saving in most environmental circumstances, the passive impeller 40 may not have sufficient power to adequately cool the light source 14 in more extreme environmental circumstances. Accordingly, to keep the temperature of the light source 14 within proper operating temperature parameters when the environment is hotter, an active impeller 60 is provided. In the depicted embodiment the active impeller 60 is an air pump powered by electricity. The air pump is controlled by a thermostat or thermistor switch 62 having a preconfigured threshold at a user selectable temperature to turn on the air pump 60. The air pump 60 takes in air from the external environment outside housing 12. The air pump 60 directs the air through air conduit 64. As best depicted on top schematic view FIG. 2, the conduit 64 may have a plurality of branches. In the depicted embodiment all of the branches extend below the light source 14. The conduit 64 includes a plurality of air exit ports 66. the air exit ports are at least generally directed towards the light source, which in the depicted embodiment means they are directed upwardly.

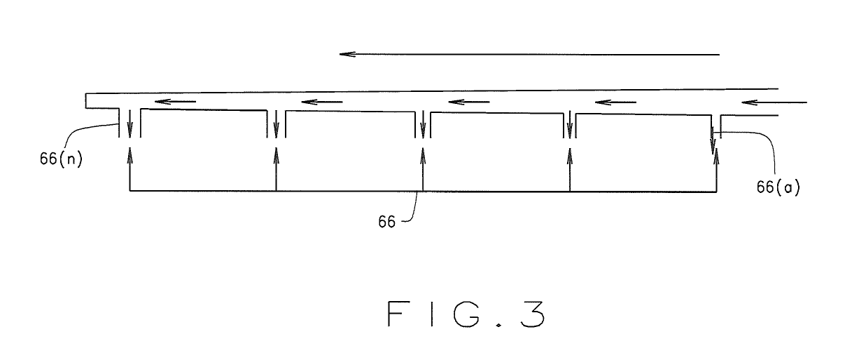

As best seen in FIG. 3, the conduit 64, or each branch of it, has a series of exit ports 66. In order to advantageously maintain a uniform flow volume and flow speed of cooling air across the entire area of the light source 14, each of the plurality of exit ports 66 will be of varying diameter. Those exit ports 66(a) closest to the air pump will have a smaller cross sectional area and those farthest from the air pump 60, ports 66(n) shall have the widest cross sectional surface area. Moreover, the conduit 64, or each branch of it, shall be tapered. The cross section of the conduit reduces in proportion to the distance from the air pump; that is, the conduit has a larger bore proximal to the air pump and a narrowing bore as it progresses more distally from the air pump. The taper works together with the increasing diameters of the exit ports 66 to maintain a constant air flow out of the conduits.

In a preferred embodiment, the plurality of exit ports 66 will be in sufficient alignment with the throughways 36 defined by holes 30, 32 and 34 in order to further promote laminar flow, or at least a minimally turbulent flow of cooling air onto, through, across and away from the light source/heat sink assembly.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

We claim:

1. An outdoor area light comprising:
a housing;
a light source comprised of a printed circuit board and a plurality of LEDs;
a heat sink, said heat sink being disposed in thermally conducive proximity to said light source;
a mounting structure mounting said light source and said heat sink in said housing;
a passive impeller mounted on said housing;
an active impeller mounted on said housing;
a conduit for air in fluid communication with said active impeller, said conduit being disposed to promote convection of heat away from said light source;
said printed circuit board having holes therethrough, and said mounting structure having holes therethrough, said holes defining fluid throughways disposed to convect heat away from said light source via air moving through said throughways; and
said fluid throughways being sufficiently aligned to maintain minimally turbulent air flow therethrough and across said light source.

2. The light of claim 1 wherein said throughways are in sufficient alignment to maintain laminar flow of air therethrough.

3. The light of claim 1 further comprising a thermostatic activation switch in operative communication with said active impeller and configured to activate said active impeller when a temperature reaches a pre-configured threshold.

4. The light of claim 1 wherein said passive impeller and said active impeller are separate impellers.

5. The light of claim 1 wherein said passive impeller is driven by an externally mounted wind driven fan.

6. The light of claim 1 wherein said heat sink includes holes, therethrough said heat sink holes further defining said fluid throughways.

7. The light of claim 1 wherein said fluid conduit has a plurality of exit ports.

8. The light of claim 7 wherein said exit ports of said fluid conduit are in sufficient alignment with said fluid throughways to promote air flow from said conduit and through said fluid throughways with minimal turbulence.

9. The light of claim 8 wherein said air flow from said plurality of conduit exit ports through said fluid throughways is laminar.

10. The light of claim 1 wherein said fluid conduit is tapered, said taper narrowing with greater distance from said active impeller.

11. The light of claim 1 wherein said fluid conduit has a plurality of exit ports, said exit ports being narrower when more near said active impeller and said exit ports being wider when said exit ports are farther from said active impeller.

12. The light of claim 1 wherein said external area light is a street light.
